(19) United States
(12) Patent Application Publication
(10) Pub. No.: US 2026/0097921 A1
(43) Pub. Date: Apr. 9, 2026

(54) STACKING DEVICE FOR STACKING SUBSTRATES

(71) Applicant: Phoenix Contact GmbH & Co. KG, Blomberg (DE)

(72) Inventors: Michael ESSLINGER, Rottweil (DE); Meinrad KEMPTER, Öhningen (DE); Jürgen GRETSCHER, Dornhan (DE)

(21) Appl. No.: 19/135,428

(22) PCT Filed: Nov. 16, 2023
(86) PCT No.: PCT/EP2023/081987

§ 371 Date: Jun. 4, 2025

(30) Foreign Application Priority Data
Dec. 7, 2022 (DE) 10 2022 132 556.3
Mar. 6, 2023 (BE) BE2023/5161

(51) Int. Cl. B65H 29/44

(52) U.S. Cl. CPC B65H 29/44; B65H 2701/192; B65H 2801/03

(57) ABSTRACT

A stacking device for stacking substrates includes: a frame; an input region; an output region; and at least one conveying element mounted on the frame so as to be completely rotatable about an axis of rotation. The at least one conveying element has a gripping portion for conveying a substrate located in the input region to the output region.

### CROSS-REFERENCE TO PRIOR APPLICATIONS

This application is a U.S. National Phase application under 35 U.S. C. § 371 of International Application No. PCT/EP2023/081987, filed on Nov. 16, 2023, and claims benefit to German Patent Application No. DE 10 2022 132 556.3, filed on Dec. 7, 2022, and Belgian Patent Application No. BE2023/5161, filed on Mar. 6, 2023. The International Application was published in German on Jun. 13, 2024 as WO 2024/120780 A1 under PCT Article 21(2).

### FIELD

The invention relates to a stacking device for stacking substrates, a printing system with such a stacking device, and a method for stacking substrates.

### BACKGROUND

For example, print media printed one after the other by a printer are typically output onto a stack. The stack or part of it can be removed by a user. Several principles for stacking are conceivable. For example, the most recently printed print medium can be placed on top of a stack. Alternatively, the most recently printed print medium can be fed into a stack from the bottom. Feeding from the bottom into a stack accessible to a user from above has the advantage that the print medium printed first is also available first.

DE 10 2020 120 256 A1 describes a printer for printing on plate-like media, viz., for printing marker cards with markers for marking electrical devices. The printer comprises a housing and at least one input station for the marker cards to be printed, a printing station with a printing device, and an output station for the printed marker cards. The output station has a magazine device which has one or more guide devices, wherein the respective guide device further has a stacking unit which is pivotably mounted and is pivoted back and forth for stacking.

DE 10 2013 104 780 A1 describes a magazine device for printed marking element mats, which has a horizontal conveyor device and a vertical lifting device that is moved in a shaft. The shaft has two symmetrical flaps that can be pivoted back and forth.

What the known devices have in common is that they are based upon a complex mechanism that is prone to jamming.

### SUMMARY

In an embodiment, the present invention provides a stacking device for stacking substrates, comprising: a frame; an input region; an output region; and at least one conveying element mounted on the frame so as to be completely rotatable about an axis of rotation. The at least one conveying element has a gripping portion configured to convey a substrate located in the input region to the output region.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a printing system for printing on print media;

FIG. 2 is a view of a print medium in the form of a label mat with a plurality of break-out identification labels;

FIG. 3A to 3C are views of a stacking device of the printing system according to FIG. 1 at different stages of conveying a print medium;

FIG. 4 is a view of a stack of print media in an output region of the stacking device according to FIG. 3A to 3C;

FIG. 5 is a view of the stacking device according to FIG. 3A to 3C, showing an additional output region;

FIG. 6 is a view of the stacking device according to FIG. 3A to 3C, showing a drive unit of the stacking device; and

FIG. 7 is a view of a passage of the stacking device according to FIG. 3A to 3C.

### DETAILED DESCRIPTION

In an embodiment, the present invention enables the simplest and most reliable stacking possible of print media.

Accordingly, a stacking device for stacking substrates, in particular print media, comprises a frame, an input region, and an output region, wherein at least one conveying element mounted on the frame so as to be completely rotatable about an axis of rotation is provided, having a gripping portion for conveying a substrate, in particular a print medium, located in the input region to the output region.

This is based upon the idea of providing a FIFO principle (“first in—first out”), in which the substrate, in particular a print medium, that is input first is also output first, with a particularly simple and robust mechanism. By providing the conveying element which can be rotated completely around the axis of rotation and which grips and conveys the respective substrate, in particular a print medium, with the gripping portion, no change in the direction of a movement is necessary. This makes the mechanism particularly simple and at the same time robust and therefore reliable. The substrates, in particular print media, can be rigid objects which, unlike, for example, paper, do not deform or deform only slightly due to their own weight.

The at least one conveying element may have a recess adjacent to the gripping portion. A substrate can engage therein during conveyance by the at least one conveying element. This enables a particularly compact design, since the axis of rotation can be positioned particularly close to the substrate.

Optionally, the at least one conveying element has an outer circular arc portion. A substrate arranged in the output region can be supported on the circular arc portion. This allows the conveying element to be repositioned, after conveying a first substrate, in order to convey a second substrate into the output region. The circular arc portion then slides past the first substrate, wherein, for example, the position of the first substrate remains unchanged. The conveying element therefore has a dual function.

The at least one conveying element can be configured to lift one or more substrates vertically against gravity into the output region. This creates a stack that is particularly easy to remove.

The output region may include a guide for guiding a stack of substrates. In this way, a neat stacking of a variety of substrates can be achieved.

The stacking device can comprise a drive unit arranged laterally offset relative to the output region. This enables a particularly compact design that can also be easily implemented in a modular manner.

The at least one conveying element can be capable of being rotated unidirectionally multiple times about the axis of rotation, in particular as often as desired-for example, in order to convey a plurality of substrates one after the other to the output region. For example, one substrate is entrained with each complete rotation. This enables continuous and consistent transport.

The at least one conveying element can be disk-shaped. This allows for a narrow design and at the same time a simple construction.

The stacking device can have two conveying elements that can be rotated in opposite directions, between which a substrate can be arranged. This allows a particularly smooth-running construction to be achieved.

Furthermore, the stacking device can comprise a first pair of conveying elements that can be rotated counter to a second pair of conveying elements. For example, each substrate can be lifted at four corners at the same time, which allows for particularly orderly stacking without tilting.

Furthermore, the stacking device can have a second output region which is separate from the output region already mentioned, wherein the substrates can be output from the input region into the separate output region as an alternative to the output region.

Optionally, the stacking device is designed to stack flat and rigid substrates, in particular print media. For example, the stacking device is designed to stack print media in the form of label mats, each with several break-out identification labels. Such label mats are also called marking element mats. The stacking device is particularly well suited for efficiently stacking such print media.

The stacking device may comprise at least one flat, rigid substrate, in particular a print medium, in particular in the form of a label mat with a plurality of break-out identification labels. This can be arranged in the input region and the output region.

According to one aspect, a printing system is provided. The printing system comprises the stacking device according to any of the embodiments described herein. Furthermore, the printing system comprises a printer and a transport device for transporting the substrates in the form of print media from the printer to the stacking device. As regards the advantages, reference is made to the above statements relating to the stacking device.

The transport device of the printing system includes, for example, at least one rail for guiding the print media. A recess for engagement by the at least one conveying element can be formed in the at least one rail. This results in a particularly compact design.

According to one aspect, a method for stacking substrates, in particular print media, is specified, in particular using the stacking device according to any embodiment described herein. The stacking device comprises a frame, an input region, an output region, and at least one conveying element mounted on the frame so as to be completely rotatable about an axis of rotation. The method comprises the following steps: arranging a substrate, in particular a print medium, in the input region; and conveying the substrate, in particular a print medium, arranged in the input region with a gripping portion of the at least one conveying element to the output region by rotating the at least one conveying element at least once about the axis of rotation. As regards the advantages, reference is again made to the above statements relating to the stacking device.

FIG. 1 shows a printing system 3 for printing on a plurality of individually printable substrates in the form of print media. For this purpose, the printing system 3 comprises a separating device 30 into which a stack of print media can be fed automatically or manually. A transport device 31 transports individual print media, output by the separating device 30, to a printer 32 of the printing system 3.

The printer 32 prints the individual print media one after the other. From the printer 32, the print media are transported to a stacking device 1 by means of the transport device 31. The stacking device 1 stacks the individual printed print media to form a stack, which can then be removed manually or automatically from the stacking device 1.

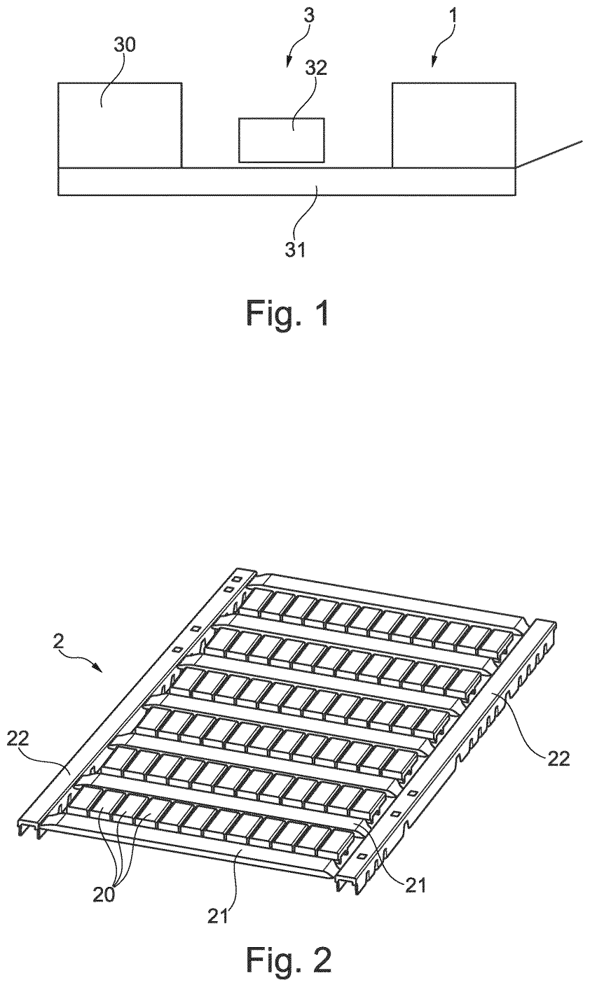

FIG. 2 shows an example of such a substrate in the form of a print medium 2. The print medium 2 comprises a plurality of identification labels 20. The identification labels 20 are each formed on (at least) one of a plurality of webs 21. The webs 21 are arranged parallel to one another and with the identification labels 20 between two guides 22. The webs 21 are each fixed to both guides 22. The print medium 2 is formed in one piece. For example, it is an injection-molded part. In particular, the print medium 2 can consist of a plastic or comprise a plastic. The individual identification labels 20 can be broken off from the webs 21. For example, an identification label 20 printed with the printer 32 can be attached to an electrical or electronic component in order to identify it. For this purpose, the identification labels 20 each have locking elements for locking with a corresponding component.

The print medium 2 can also be called a mat or card. It is disk-shaped and rigid. Due to the weight of the print medium 2, the print medium 2 does not bend or only bends slightly—for example, when it is held only on one side or corner.

The print medium 2 has a length, a width, and a height. The height is smaller than the length and width. The width is smaller than the length. The guides 22 extend along the length. The end faces of the print medium 2 extend across its width.

Depending upon the required shape and size of the identification labels 20, the print medium 2 can have a larger or smaller number of identification labels 20 and webs 21 for holding the identification labels 20.

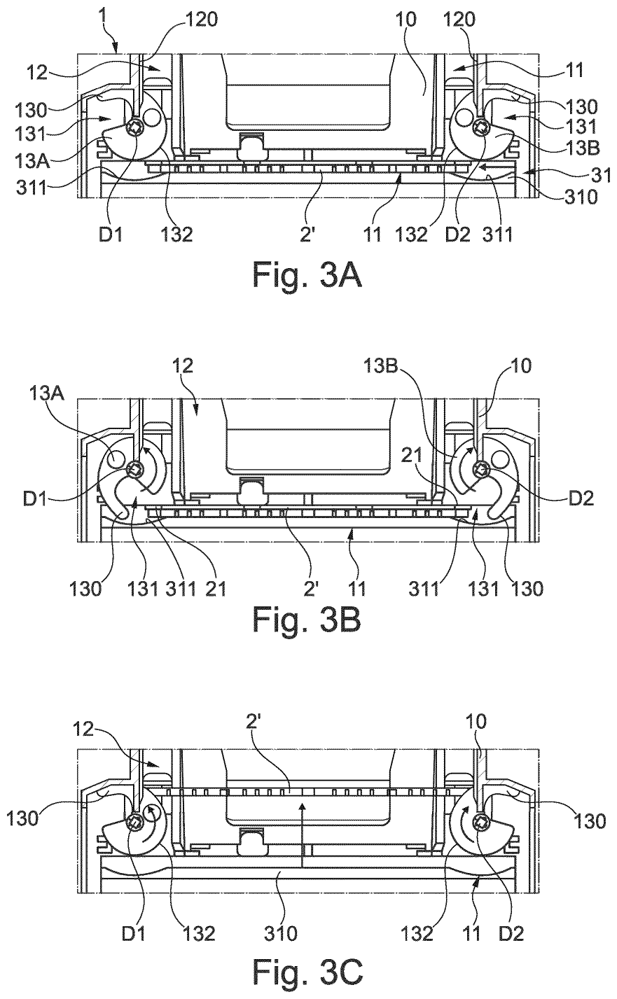

FIG. 3A to 3C show the stacking device 1 and its mode of operation.

The stacking device 1 comprises a frame 10, an input region 11, and an output region 12. When the stacking device 1 is used as intended, the output region 12 is arranged vertically above the input region 11. By means of the transport device 31, a print medium 2′ can be moved, in this case slid, from the printer 32 to the input region 11. For this purpose, the transport device 31 has a pair of rails 310, wherein each of the guides 22 of the print medium 2 sits on one of the rails 310 and is thereby guided in a longitudinally displaceable manner. FIG. 3A illustrates with an arrow the conveyance of the print medium 2′ shown in FIG. 3A into the arrangement of the print medium 2′, shown in the figure, in the input region 11. The rails 310 of the transport device 31 are spaced apart from one another. The rails 310 of the transport device 31 run parallel to one another. During the use as intended of the stacking device 1 (and the printing system 3), the rails 310 extend horizontally.

Furthermore, the stacking device 1 generally comprises at least one conveying element 13A, 13B; in the example shown, there are exactly four conveying elements 13A, 13B. Each of the conveying elements 13A, 13B is mounted on the frame 10 so that it can rotate completely, i.e., by 360 degrees, about an associated axis of rotation D1, D2. As can be seen in particular in FIGS. 5 and 7, the stacking device 1 comprises a first pair of conveying elements 13A, which is rotatable in a first direction (counter-clockwise in the view according to FIG. 3A), and a second pair of conveying elements 13B, which is rotatable in a second direction counter to the first direction (clockwise in the view according to FIG. 3A). Alternatively, however, it would also be conceivable, for example, for the stacking device to have exactly two conveying elements which are arranged, for example, on opposite sides of the input region 11, so that they are arranged on opposite sides of a print medium 2′ located in the input region 11.

Of the four conveying elements 13A, 13B in the present case, two (viz., the first pair) are arranged on one side of the input region 11, and two further ones (viz., the second pair) are arranged on an opposite side of the input region 11, and thus also correspondingly on opposite sides of a print medium 2′ positioned in the input region 11. In the example shown, the conveying elements 13A, 13B engage the end faces of the print medium 2. Specifically, in the example shown, the conveying elements 13A, 13B are arranged such that they are located at four corners of a rectangular print medium 2′ positioned in the input region 11.

In the present case, the conveying elements 13A, 13B are of identical design. The first pair is oriented in the opposite direction in comparison to the second pair.

Each of the conveying elements 13A, 13B has a gripping portion 130 for gripping a print medium 2′ located in the input region 11 and for conveying the print medium 2′ to the output region 12. The gripping region 130 is designed here in the form of a protrusion. By rotating the respective conveying element 13A, 13B about the corresponding axis of rotation D1, D2, the gripping portion 130 engages under the print medium 2′ positioned in the input region 11 and lifts it, as will be explained in more detail below.

Adjacent to the gripping portion 130, a recess 131 is formed in the conveying element 13A, 13B. When conveyed by the conveying elements 13A, 13B, the print medium 2′ engages in the respective recesses 131.

Furthermore, the conveying elements 13A, 13B each have a circular arc portion 132. A print medium 2′ arranged in the output region 12 can be supported on the circular arc portion 132, while the conveying element 13A, 13B continues to rotate. The circular arc portion 132 is arranged concentrically to the respective axis of rotation D1, D2. The gripping portion 130 is formed eccentrically to the circular arc portion 132 (and to the axis of rotation D1, D2). The gripping portion 130 extends further outwards in the radial direction perpendicular to the axis of rotation D1, D2 than the circular arc portion 132. The gripping portion 130 of a respective conveying element 13A, 13B is oriented such that it points in the respective direction of rotation of the conveying element 13A, 13B. The extended gripping portions 130 enable the print media 2′ to be picked up without having to lift them using separate elements. The respective print medium 2′ remains at a transport height in the input region 11 until it is picked up by the gripping portions 130. No additional mechanism is necessary here.

The conveying elements 13A, 13B are flat (along the axis of rotation D1, D2). The conveying elements 13A, 13B are disk-shaped in the present case. The conveying elements 13A, 13B can also be referred to as profiled disks. The stacking is therefore carried out using profiled disks.

The stacking device 1 is placed on the transport device 31. The conveying elements 13A, 13B are each aligned with one of the rails 310 of the transport device 31. In each of the two rails 310, a recess 311 is formed for each two of the conveying elements 13A, 13B (i.e., one recess 311 per conveying element 13A, 13B). The gripping portions 130 of the conveying elements 13A, 13B engage in these recesses 311 when they rotate about the respective axis of rotation D1, D2. This allows the gripping portions 130 to easily grip under the print medium 2′ sitting on the rails 311. The conveying elements 13A, 13B each engage in the guides 22 of the print medium 2′. This ensures that the print medium 2′ sits securely during conveyance.

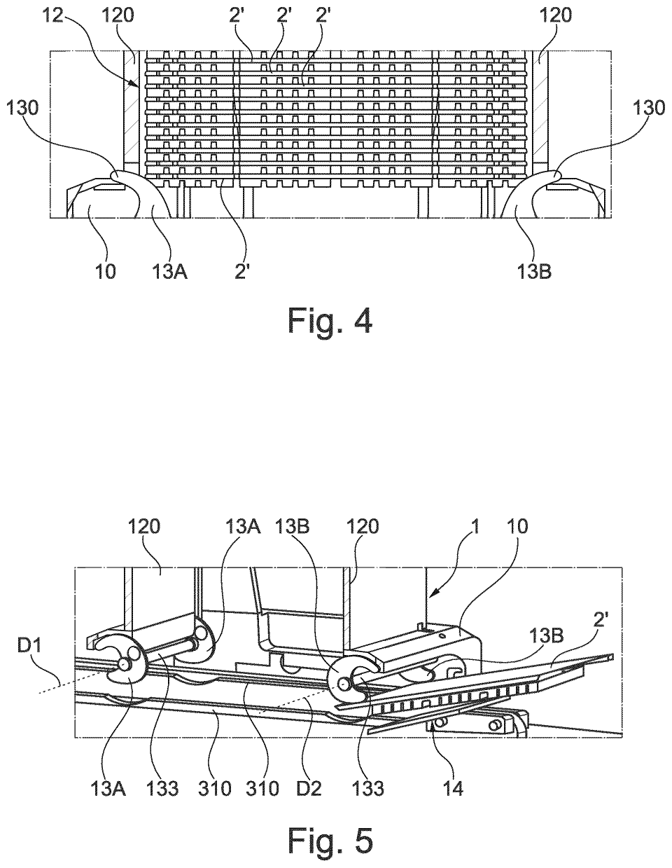

Referring to FIG. 3A to 3C and 4, a method for stacking print media 2′ with the separating device 1 is now explained.

In a first step, a print medium, e.g., the print medium 2 shown in FIG. 2 or the print medium 2′ shown in FIG. 3A-3C, is conveyed into the input region 11, as illustrated in FIG. 3A by the arrow. In the example shown, this movement occurs in the horizontal direction. The print medium 2′ then lies ready in the input region 11. The conveying elements 13A, 13B have previously been arranged such that the gripping portions 130 do not interfere with the movement of the print medium 2 along the rails 310. For example, the conveying elements 13A, 13B are rotated so that the gripping portions 130 point upwards.

Next, the print medium 2′ arranged in the input region 11 is conveyed to the output region 12 by means of the gripping portions 130 of the conveying elements 13A, 13B by rotating the at least one conveying element 13A, 13B about the axis of rotation D1, D2. The conveying elements 13A, 13B each mesh in a rotating manner with the end faces of the print medium 2′. In the present case, the conveying elements 13A, 13B are rotated completely once about the axis of rotation D1, D2, i.e., by 360 degrees, for each print medium 2′ to be stacked. Alternatively, it would also be conceivable for the conveying elements 13A, 13B to each have two (or more) gripping portions, so that two (or more) print media 2′ can be conveyed per complete rotation. Because the conveying elements 13A, 13B are completely rotatable about the axes of rotation D1, D2, the stacking of a plurality of print media 2′ can be carried out by a unidirectional rotational movement, i.e., without switching the direction of rotation. This allows for a particularly simple drive mechanism, which is described in more detail below, and which also does not tend to jam, due to the lack of a switching of the direction of rotation. The rotational movement can be stopped between the transport of two print media 2′, or, alternatively, can continue to run continuously. All conveying elements 13A, 13B move synchronously. The movements of the conveying elements 13A, 13B are coupled to one another.

FIG. 3B shows a moment in which the gripping portions 130 dip into the recesses 311 in the rails 310 of the transport device 31, shortly before they grip under one of the webs 21 (and/or one of the guides 22) of the print medium 2′ by further rotation about the axes of rotation D1, D2. As soon as the gripping portions 130 come into contact with the webs 21, the print medium 2′ is lifted upon further rotation of the conveying elements 13A, 13B in the vertical direction, counter to the direction of gravity, as illustrated by an arrow in FIG. 3C.

FIG. 3C shows a moment in which the gripping portions 130 have already rotated further, and their ends are no longer in contact with the print medium 2′. Rather, the print medium 2′ rests on the respective conveying element 13A, 13B at a transition to the circular arc portion 132. Upon further rotation of the conveying elements 13A, 13B, the print medium 2′ therefore slides on the circular arc portions 132. These rotate under the print medium 2′, while the print medium 2′ remains stationary in the output region 12. The print medium 2′ then rests on the respective outer diameter of the conveying elements 13A, 13B.

FIG. 4 shows the arrangement of a plurality of print media 2′ into a stack in the output region 12. The stacking device 1 always feeds additional print media 2′ to the stack from below, thus lifting the stack above it.

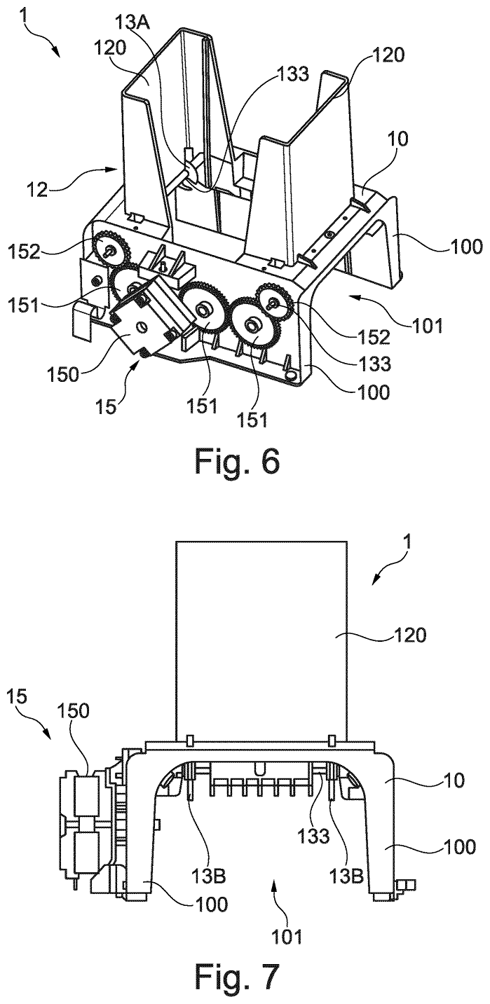

The output region 12 has a guide 120 for guiding a stack of print media 2′. The guide 120 borders the output region 12 laterally. The guide 120 forms a shaft for the print media 2′. The guide 120 is open at the top so that the stack of print media 2′ can be removed. To facilitate removal, the guide 120 has two, opposite lateral slots, as can be seen, for example, in FIGS. 5 and 6.

FIG. 5 also shows an optional, separate output region 14 of the stacking device 1. A respective print medium 2; 2′ can, selectively, either be stacked by the stacking device 1 in the output region 12 or transported individually from the input region 11 into the separate output region 14, e.g., by means of the transport device 31. In the present case, the separate output region 14 is inclined relative to the rails 311 to facilitate removal. The separate output region 14 can also be referred to as an outfeed. For example, if it is determined that a single print medium is incorrectly printed or of the wrong type, it can be ejected into the separate output region 14 so that it does not end up in the stack. Also, if a print medium is to be processed with priority, it can be guided so as to bypass the stack.

FIGS. 6 and 7 show a drive unit 15 of the stacking device 1. The drive unit 15 comprises a motor 150 and several gears 151, 152. Furthermore, it can be seen that each pair of conveying elements 13A, 13B is fixed in a rotationally fixed manner to a shaft 133. Furthermore, one of the gears 152 is fixed in a rotationally fixed manner to each of the two shafts 133. In order to effect the opposite directions of rotation of the pairs of conveying elements 13A, 13B (and the two shafts 133), the drive unit 15 has a number of gears 151, 152 connected in series that differs by one for the first pair and the second pair. Thus, a drive pinion of the motor 150 drives the shaft 133 shown on the left in FIG. 6 via a total of two gears 151, 152, while the drive pinion drives the shaft 133, arranged on the right in the view of FIG. 6, via a total of three gears 151, 152.

A sensor (e.g., in the motor 15) detects the position of the conveying elements 13A, 13B, i.e., in particular, a current angle of rotation (e.g., relative to the frame 10). In this way the motor 15 can adjust the stacking to the conveyance by the transport device 31.

As can be seen in particular from FIGS. 6 and 7, the frame 10 has two arms 100. Whereas the guide 120 of the output region 12 extends vertically upwards, the arms 100 extend vertically downwards. There is a passage 101 between the arms 100. The passage 101 is designed to receive a portion of the transport device 31 of the printing system 3. In the assembled state, the transport device 31 of the printing system 3 extends in the passage 101.

The drive device 15 is arranged laterally offset from the output region 12. This frees up the installation space under the output region 12. This allows a particularly compact and also modular design. Furthermore, this arrangement allows the use of the separate output region 14, because the installation space at the transport height is not blocked. In addition, the installation space in front of and behind the end faces of the print media 2 is not blocked by the drive.

When rotated in the opposite direction, the stacking device can also be used as a separating device for separating and feeding stacked print media 2. This results in a large number of identical parts.

Specifically, the drive device 15 is mounted on one of the arms 100. The drive device 15 is arranged below the output region 12.

The stacking device 1 shown enables stacking according to the FIFO principle, so that a print medium 2, 2′ printed first is also available first.

The conveying elements 13A, 13B actively lift the print media 2, 2′, and no external force is necessary which could deform the print media 2, 2′. Furthermore, the print media 2, 2′ are raised at the front, which enables a very simple and cost-effective construction.

Since the picking up, lowering, and retention of the print media 2, 2′ is realized by a rotational movement (per conveying element 13A, 13B) in only one direction of rotation, an empty stroke can be avoided. Furthermore, alternating loading and the corresponding wear are eliminated. In addition, very few components are required, thus achieving low complexity and susceptibility to failure.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Stacking device
10 Frame
100 Arm
101 Passage
11 Input region
12 Output region
120 Guide
13A, 13B Conveying element
130 Gripping portion
131 Recess
132 Circular arc portion
133 Shaft
14 Separate output region
15 Drive unit
150 Motor
151 Gear
152 Gear
2, 2′ Print medium
20 Identification tag
21 Ridge
22 Guide
3 Printing system
30 Separating device
31 Transport device
310 Rail
311 Depression
32 Printer
D1, D2 Axis of rotation

1. : A stacking device for stacking substrates comprising:
a frame;
an input region; and
an output region; and
at least one conveying element mounted on the frame so as to be completely rotatable about an axis of rotation, the at least one conveying element having a gripping portion configured to convey a substrate located in the input region to the output region.

2. The stacking device of claim 1, wherein the at least one conveying element has a recess adjacent to the gripping portion, the recess being configured to engage a substrate therein during conveyance by the at least one conveying element.

3. The stacking device of claim 1, wherein the at least one conveying element has an outer circular arc portion on which a substrate arranged in the output region is supportable.

4. The stacking device of claim 1, wherein the at least one conveying element is configured to lift the substrate vertically into the output region.

5. The stacking device of claim 1, wherein the output region has a guide configured to guide a stack of substrates.

6. The stacking device of claim 1, further comprising:
a drive unit arranged laterally offset from the output region.

7. The stacking device of claim 1, wherein the at least one conveying element is rotatable unidirectionally multiple times about the axis of rotation in order to convey a plurality of substrates one after another to the output region.

8. The stacking device of claim 1, wherein the at least one conveying element comprises a disk.

9. The stacking device of claim 1, wherein the at least one conveying element comprises two, oppositely rotatable conveying elements, between which the substrate is arrangeable.

10. The stacking device of claim 9, wherein the two, oppositely rotatable conveying elements comprise a first pair of conveying elements rotatable counter to a second pair of conveying elements.

11. The stacking device of claim 1, further comprising:
a separate output region into which substrates are outputtable from the input region.

12. The stacking device of claim 1, wherein the stacking unit is configured to stack substrates comprising flat, rigid print media, comprising sign mats, each with a plurality of break-out identification labels.

13. The stacking device of claim 1, further comprising:
the substrate, the substrate comprising at least one rigid substrate comprising a label mat with a plurality of break-out identification labels.

14. A printing system comprising:
the stacking device of claim 1;
a printer; and
a transport device configured to transport the substrate from the printer to the stacking device,
wherein the substrate comprises print media.

15. The printing system of claim 14, wherein the transport device comprises at least one rail configured to guide the substrate, in which a recess is formed for engagement by the at least one conveying element.

16. A method for stacking substrates with the stacking device of claim 1, the method comprising:
arranging the substrate in the input region; and
conveying the substrate arranged in the input region to the output region with a gripping portion of the at least one conveying element by rotating the at least one conveying element completely about the axis of rotation.
